(19) United States
(12) Patent Application Publication
(10) Pub. No.: US 2018/0326527 A1
(43) Pub. Date: Nov. 15, 2018

(54) Welding Arc Powered Spool Gun

(71) Applicant: Hobart Brothers Company, Troy, OH (US)

(72) Inventor: Darrell Lee Sickels, Troy, OH (US)

(21) Appl. No.: 16/044,860

(22) Filed: Jul. 25, 2018

Related U.S. Application Data
(63) Continuation of application No. 13/427,677, filed on Mar. 22, 2012, now abandoned.
(60) Provisional application No. 61/467,457, filed on Mar. 25, 2011.

(51) Int. Cl. B23K 9/12; B23K 9/32; B23K 9/133; B23K 9/29

(52) U.S. Cl. CPC B23K 9/124; B23K 9/32; B23K 9/295; B23K 9/133

(57) ABSTRACT

The present disclosure provides a welding system having a welder and a 12V spool gun, in which the 12V spool gun includes a 12V motor. The 12V spool gun receives a voltage that is derived from a welding arc voltage, and drives the 12V motor of the 12V spool gun with the derived voltage. The present techniques allow for the use of a spool gun requiring motor power to be used with any ordinary welder.

### CROSS REFERENCE TO RELATED APPLICATIONS

This application is a Non Provisional patent application of U.S. Provisional Patent Application No. 61/467,457, entitled “12V Spool Gun”, filed Mar. 25, 2011, which is herein incorporated by reference in its entirety.

### BACKGROUND

The present disclosure relates generally to welding equipment, including welders and welding guns. Specifically, the present disclosure relates to a 12 volt spool gun.

Many small wire welders that are available are equipped with a welding gun for the purpose of delivering welding wire to a welding arc to be consumed as a filler metal in a weldment. Typically, the welding wire is pushed through a gun cable by a welding wire drive mechanism located in the welder. However, when welding with a soft filler metal, such as aluminum, the feeding of the welding wire through the welding gun may be problematic as soft welding wire is prone to binding in some welding guns. The welding wire feeding issues encountered may cause temporary or total arc outages. In the worst case, the wire may feed back into the welder, causing a “bird's nest” of welding wire in the welding wire drive mechanism.

One method for resolving this issue is to employ a welding gun with a shorter welding wire travel path to minimize the welding wire restrictions. Such a welding gun is known as a “spool gun” because the welding wire spool and welding wire drive mechanism are located in a handle end of the spool gun closest to the welding arc. This configuration allows softer filler metal welding wire to be delivered to the welding arc in a straight, short (e.g., approximately 10″) path. Since the welding wire spool and welding wire drive mechanism are located in the spool gun rather than the welder, power must be provided to the spool gun to drive a motor within the spool gun.

Unfortunately, many existing welders are not readily adaptable to be used with a spool gun. Adapting a spool gun to a welder that is not “spool gun ready” may be an expensive and complicated exercise. This problem is exacerbated when the welder is a relatively low-cost welder.

Existing spool gun designs include a 24V motor. As such, it is relatively difficult and expensive to add circuitry to drive the motor in the spool gun since most of the small, low-cost wire drive welders utilize a lower voltage integrated wire drive motor and do not generally have the capability of delivering the proper motor voltage to the 24V spool gun. Most of these low cost wire welders derive power for their integrated wire drive motor from the welding arc. However, the arc voltage under load is typically too low to fully drive the spool gun motor to the desired speeds.

### BRIEF DESCRIPTION

In an exemplary embodiment, a welding system includes a welding spool gun. The welding spool gun further includes a spindle configured to receive a welding wire spool, and a motor configured to drive rotation of a feed roll which draws welding filler metal wire from the welding wire spool. The motor is powered by a derived voltage derived from a welding arc voltage.

In another embodiment, a method includes deriving a derived voltage from a welding arc voltage and providing the derived voltage to a motor disposed in a welding spool gun.

In another embodiment, a welding system includes a welding power supply unit, and a welding spool gun coupled to welding power supply unit. The welding spool gun includes a spindle configured to receive a welding wire spool, and a motor configured to drive rotation of a feed roll which draws welding filler metal wire from the welding wire spool, in which the motor is powered by a derived voltage derived from a welding arc voltage.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of a welding system including a welder, a 12V spool gun, and a welding gun adapter, in accordance with embodiments of the present disclosure;

FIG. 2 is a diagrammatical representation of the welding system of FIG. 1, in accordance with embodiments of the present disclosure;

FIG. 3 is a perspective view of a welding gun adapter, in accordance with embodiments of the present disclosure;

FIG. 4 is an exploded perspective view of the welding gun adapter having a housing structure and a circuit board, in accordance with embodiments of the present disclosure;

FIG. 5 is a block diagram illustrating the functionality of the welding gun adapter, in accordance with aspects of the present disclosure;

FIG. 6 is a circuit diagram of the welding gun adapter, in accordance with aspects of the present disclosure; and

FIG. 7 is a perspective view of a welding system having a welder and a 12V spool gun, in accordance with aspects of the present disclosure.

### DETAILED DESCRIPTION

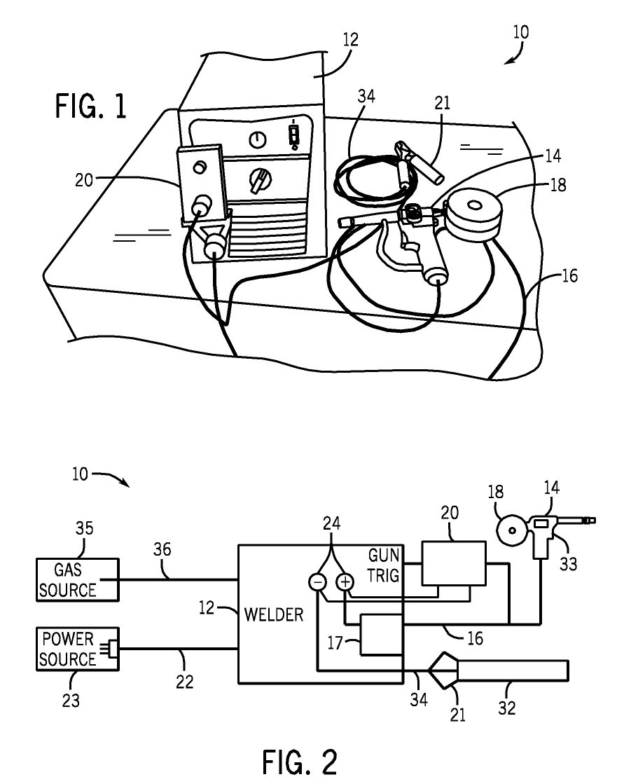

The present disclosure provides a welding system wherein weld output power from a welder may be used to provide control power and 12 volt motor power to a spool gun directly or via a spool gun adapter. As such, the 12V spool gun presented herein provides a relatively inexpensive method of operating a spool gun with welders that may not otherwise be “spool gun ready.” FIG. 1 is a perspective view of a welding system 10 in which power is provided to a 12V spool gun 14 from a welder 12. In this embodiment, the welding system 10 includes the welder 12, the 12V spool gun 14, a welding gun cable 16, and a welding gun adapter 20. Generally, the 12V spool gun 14 includes a spindle configured to receive a welding wire spool 18, the spindle and welding wire spool 18 being driven by a 12V motor (e.g., a motor rated to be powered by 12V voltage) located on the 12V spool gun 14. In particular, in certain embodiments, the 12V motor drives rotation of a feed roll, which draws welding filler metal wire from the welding wire spool 18 of the 12V spool gun 14. Additionally, the welding system 10 may also include a work clamp 21 and a work cable 34. The welding system 10, specifically the welder 12, will typically be coupled to a power source, such as a power grid. Other power sources may, of course, be utilized including generators, engine-driven power packs, and so forth. As described in greater detail below, the welder 12 may also provide control power and motor power to the 12V spool gun 14 directly, without the welding gun adapter 20.

In some embodiments, the welder 12 may output a welding arc voltage, and the 12V spool gun 14 may include a motor rated at 12V, which is configured to accept as input a derived voltage that is derived from the welding arc voltage. For example, in certain embodiments, the 12V spool gun 14 may be powered by a maximum of approximately 17.6V DC input voltage.

FIG. 2 is a diagrammatical representation of one embodiment of the welding system 10 of FIG. 1. As illustrated, the welder 12 receives AC power from a power source 23 via a power cord 22 and outputs welding power at a welder output 24. As illustrated, the welder output 24 includes a positive and a negative terminal. The 12V spool gun 14 is coupled to a wire drive assembly 17 via the welding gun cable 16, the wire drive assembly 17 being coupled to the positive terminal of the welder output 24. The welding gun cable 16 may include a coaxial gas line (passage) inside the cable 16 to allow shielding gas to flow from the wire drive assembly 17 to the 12V spool gun 14.

As described in greater detail below, welding power from the welder 12 is delivered to the 12V spool gun 14 such that the 12V spool gun 14 may produce a welding arc on a workpiece 32. The 12V spool gun 14 will typically include a welding wire spool 18 of welding wire. The welding wire is advanced through the 12V spool gun 14 by a welding wire drive assembly, typically through the use of an electric motor under the control of control circuitry within either the 12V spool gun 14 or the welder 12. The workpiece 32 is coupled to the negative terminal of the welder output 24 via the work cable 34. The work cable 34, being coupled to the negative terminal of the welder output 24 on one end, may be coupled to the workpiece 32 on the opposing end via the work clamp 21, such that the workpiece 32 is electrically coupled to the negative terminal of the welder output 24, effectively “grounding” the workpiece 32 and completing a circuit from the welder 12 to the 12V spool gun 14 to the workpiece 32 (via a welding arc) and back to the welder 12.

Additionally, as illustrated, in certain embodiments, the welder 12 may be coupled to the welding gun adapter 20 via both the positive and negative terminals of the welder output 24, and supplies welding arc voltage to the welding gun adapter 20. The welding gun adapter 20 may filter the welding arc voltage received from the welder 12 into the derived voltage to be used for adapter circuit control and motor power for the connected 12V spool gun 14. However, in other embodiments, the welder 12 may be directly coupled to the 12V spool gun, in which the 12V spool gun may receive a derived voltage that is derived from the welding arc voltage of the welder 12. The derived voltage is generally a regulated voltage that is lower than the welding arc voltage from the welder 12. Generally, the derived voltage provided to the 12V spool gun 14 may be within a range of approximately 15V-30V. For example, the derived voltage may be 17.6V DC. In general, the derived voltage may be regulated such that it provides adequate operating power to a motor of the 12V spool gun 14, which is rated at 12V.

The 12V spool gun 14 also includes a trigger 33, which when activated, relays a trigger signal to a trigger circuit of the welder 12 via the welding gun adapter 20. When the trigger 33 of the 12V spool gun 14 is triggered, the welder 12 supplies weld power to the 12V spool gun 14 for establishing an arc, and to the welding gun adapter 20 for control power and power to drive the motor of the 12V spool gun 14. Thus, when the trigger 33 of the 12V spool gun 14 is activated, the welding wire spool 18 feeds welding wire through the 12V spool gun 14 to the welding arc created by welding power from the welder 12. As a result, the weld wire is molten, and a weld is made on the workpiece 32. In addition, in certain embodiments, the welding gun adapter 20 includes control circuitry, which regulates the feeding of welding wire from the welding wire spool 18 of the 12V spool gun 14.

In certain embodiments, the welder 12 is also coupled to a shielding gas source 35 via a gas hose 36. To shield the weld area from being oxidized or contaminated during welding, to enhance arc performance, and to improve the resulting weld, the welder 12 feeds the shielding gas to the 12V spool gun 14 via the welding gun cable 16, as previously mentioned. A variety of shielding materials for protecting the weld location may be employed, including inert shielding gas, including active gases, and particulate solids.

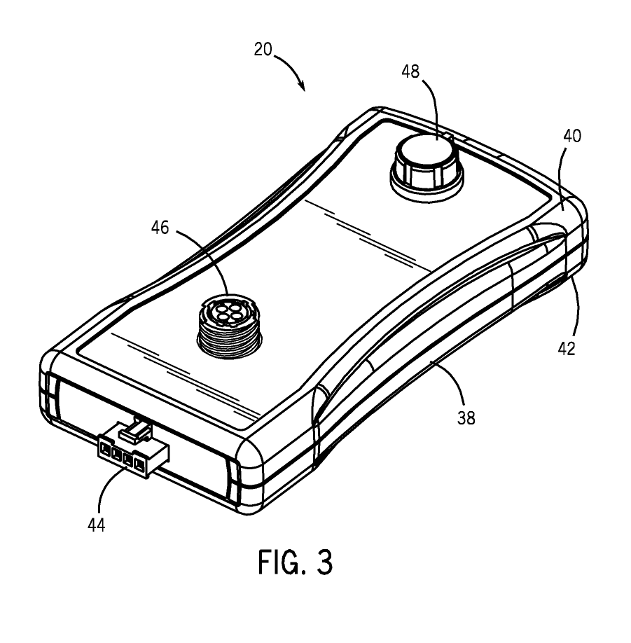

FIG. 3 is a perspective view of an exemplary welding gun adapter 20 used in certain embodiments with the 12V spool gun 14. As illustrated, the welding gun adapter 20 includes an adapter housing 38 having a top cover 40 and a bottom cover 42. The welding gun adapter 20 also includes a welder connector 44 disposed on one side of the welding gun adapter 20. The welder connector 44 further includes four connections configured to connect to the welder output 24 terminals and the welder trigger circuit, as described above. Additionally, a welding gun connector 46 is disposed on another side of the welding gun adapter 20. The illustrated welding gun connector 46 includes a 4-pin receptor for receiving and coupling to the 12V spool gun 14 via the welding gun cable 16. In certain embodiments, the welder connector 44 and the welding gun connector 46 may include different connector types other than those shown in FIG. 3. Likewise, certain embodiments may include welder connectors 44 and welding gun 46 connectors having different physical attachment mechanisms such as clips, locks, and so forth. Moreover, in certain embodiments, the physical location of the welder connector 44 and the welding gun connector 46 may be different than shown in FIG. 3.

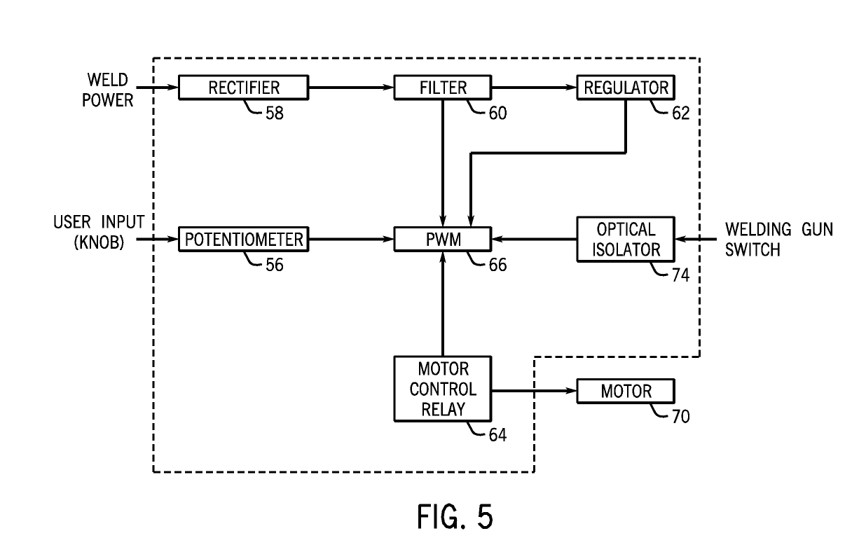

Additionally, in certain embodiments, the welding gun adapter 20 includes a knob 48 disposed on a surface of the welding gun adaptor 20. The knob 48 provides a user interfacing mechanism that may be used to control the motor speed of the motor of the 12V spool gun 14, how fast welding wire is delivered from the welding wire spool 18, and so forth. In certain embodiments, the knob 48 may be replaced with other user interfacing mechanisms for controlling motor speed, such as switches, buttons, sliders, and so forth. The welding gun adapter 20 may also include a physical attachment mechanism for securing the welding gun adapter 20 to the welder 12 as configured in FIG. 1. The attachment mechanism may include clips, holders, adhesives, and so forth. In certain embodiments, the welding gun adapter 20 may be configured to be attached to the 12V spool gun 14. In other embodiments, the welding gun adapter 20 may be part of a cable connecting the 12V spool gun 14 to the welder 12. The welding gun adapter 20 illustrated in FIG. 3 is one of many possible configurations of the welding gun adapter 20, including those of different size, shape, and arrangement of elements. Furthermore, certain embodiments may include other elements, such as additional inputs, outputs, and user interfacing elements that are not shown in the embodiment illustrated in FIG. 5.

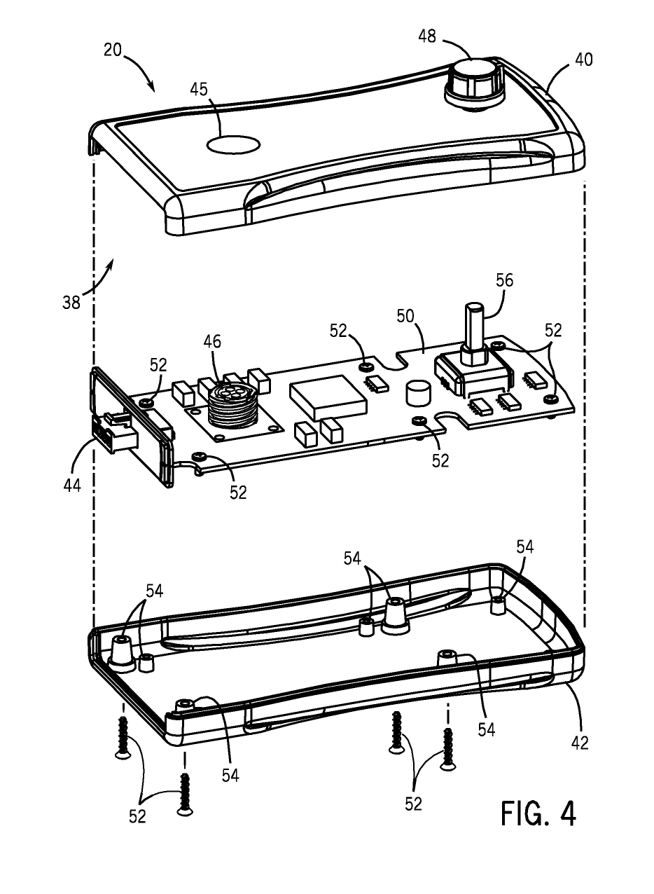

FIG. 4 is an exploded perspective view of the welding gun adapter 20 of FIG. 3. As illustrated, the welding gun adapter 20 includes a circuit board 50 disposed between the top cover 40 and the bottom cover 42 of the adapter housing 38. The circuit board 50 includes electronic components configured to establish an adapter circuit for carrying out the disclosed techniques, such as receiving power from the welder 12 and providing control power and motor power to the 12V spool gun 14, the details of which are described in greater detail below. As illustrated in FIG. 4, the welder connector 44 is coupled to the circuit board 50 such that the power received from the welder 12 enters the adapter circuit, and also such that the trigger circuit of the welder 12 is coupled to the adapter circuit via the welder connector 44. Likewise, the welding gun connector 46 is also coupled to the circuit board 50. The welding gun adapter 20 couples to the 12V spool gun 14 via the welding gun connector 46, providing power to the 12V spool gun 14 and receiving a trigger signal from the trigger 33 of the 12V spool gun 14. As such, the top cover 40 includes a through hole 45 which allows the welding gun connector 46 to be exposed when the adapter housing 38 is closed.

The circuit board 50 also includes a potentiometer 56 coupled to the adapter circuit. The potentiometer 56 is physically coupled to the knob 48 disposed on the surface of the welding gun adapter 20 such that the potentiometer 56 turns in a proportional manner when the knob 48 is turned. This allows a user to control the potentiometer 56, and hence the motor voltage and motor speed using the welding gun adapter 20. As illustrated, the circuit board 50 is disposed inside the adapter housing 38 such that the top cover 40 and the bottom cover 42 fully enclose the circuit board 50 when closed. Additionally, the circuit board 50 is supported and stabilized inside the adapter housing 38 by a plurality of screws 52 and standoffs 54. In the illustrated embodiment, the standoffs 54 are attached to the bottom cover 42 such that the circuit board 50 may be configured to sit on top of the standoffs 54, leaving space between the circuit board 50 and the inside surface of the bottom cover 42, thereby enabling heat dissipation within the welding gun adapter 20. The standoffs 54 are designed to receive and hold a respective screw 52. Accordingly, the circuit board 50 also includes screw holes established on the circuit board 50 at corresponding locations such that the screw holes are generally aligned with the standoffs 54. Screws 52 are inserted into the screw holes of the circuit board 50 and screwed into the standoffs 54 such that the circuit board 50 is secured between the screw heads and the standoffs 54, and secured to the bottom cover 42. In the illustrated embodiment, the standoffs 54 and screw holes are generally placed near the edges of the bottom cover 42 and at corresponding locations on the circuit board 50, respectively. In certain embodiments, the standoffs 54 and screw holes may be placed in various locations and be varied in number. In some embodiments, the standoffs 54 may be attached to the top cover 40 rather than the bottom cover 42, with the circuit board 50 being secured to the top cover 40 rather than the bottom cover 42. Additionally, in certain embodiments, the circuit board 50 may be disposed and secured within the adapter housing 38 in a manner different than that described above. For example, the circuit board 50 may be held by grooves along inside edges of the adapter housing 38, or held by clips, and so forth.

The top cover 40 and the bottom cover 42 may be joined together to encase the circuit board 50, as shown in FIG. 3. In the illustrated embodiment, the top cover 40 and the bottom cover 42 are secured in a closed position by screws 52 that screw into and past the bottom cover 42 into screw receptacles at corresponding locations in the top cover 40. Thus, the screws 52 thread the bottom cover 42 and top cover 40 together, holding the top and bottom covers 40, 42 in a joined and closed position, housing the circuit board 50 inside. Alternatively, the adapter housing 38 may be joined together in a manner different that described above. For example, the adapter housing 38 may be closed by sliding one cover onto the other, employing a latch or clip closing mechanism, and so forth. In certain embodiments, the adapter housing 38 may instead be a one-piece housing, removing the need for top and bottom covers 40, 42.

Regardless of the specific features of the adapter housing 38, it is noted that the welding gun adapter 20 is relatively simple in design, including a relatively small number of main components (e.g., the adapter housing 38, the circuit board 50 that includes the adapter circuit, the potentiometer 56 connected to the knob 48, the welder connector 44, and the welding gun connector 46). As such, the welding gun adapter 20 may be manufactured relatively inexpensively, while providing the valuable benefit of adapting welders that are not “spool gun ready” with spool guns, such as the 12V spool gun 14 described herein.

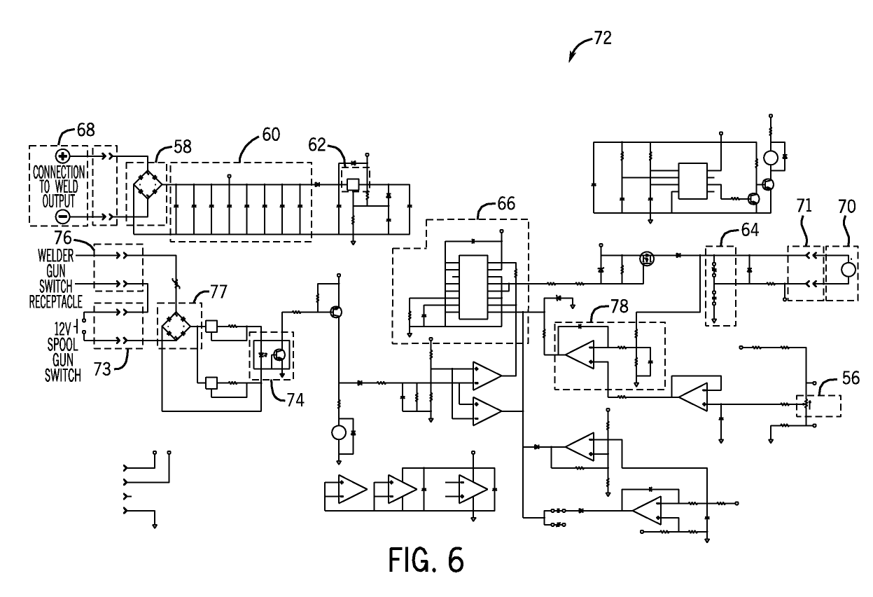

FIG. 5 is a block diagram of certain functionality of the adapter circuit 72 of the welding gun adapter 20 derived from the more detailed circuit diagram of the adapter circuit 72 illustrated in FIG. 6. As such, FIGS. 5 and 6 will be generally referred to concurrently to disclose both the theory and specific implementation of each portion of the adapter circuit 72 of the welding gun adapter 20 described herein. It will be appreciated that the functionality and associated circuitry of the adapter circuit 72 illustrated in FIGS. 5 and 6 is embodied on the circuit board 50 illustrated in FIG. 4. As illustrated in FIG. 5, the adapter circuit 72 of the welding gun adapter 20 generally includes a rectifier 58, a filter 60, a regulator 62, a motor control relay 64, a pulse width modulator 66, an optical isolator 74, and the potentiometer 56. As illustrated, the adapter circuit 72 of the welding gun adapter 20 also interacts with a 12V spool gun motor 70 (e.g., a motor rated at 12 volts) of the 12V spool gun 14.

Referring now to FIG. 6, as described above, in certain embodiments, the welding gun adapter 20 may include four connections to the welder 12 (e.g., via the welder connector 44 illustrated in FIGS. 3 and 4). Two of the connections are power input connections 68 which connect to the welder output 24 of the welder 12. The other two connections are trigger circuit connections 76 connected to the trigger circuit of the welder 12. Specifically, the welding arc voltage enters the welding adapter 20 through two of the four input receptacles (e.g., the power input connections 68) of the welder connector 44, one being a positive terminal and one being a negative terminal. The welding arc voltage received from the welder 12 is typically rectified by the rectifier 58, such that the connections are not polarity sensitive. The rectifier 58, the specific design of which is shown in FIG. 6, employs a diode bridge for rectifying the input voltage. In the illustrated embodiment, this function may be accomplished by a plurality of capacitors, as shown. The filtered (e.g., derived) voltage supply may provide motor power for the 12V spool gun motor 70 of the 12V spool gun 14, as well as control power. In the illustrated embodiment, the regulator 62 employs a linear regulator as shown in FIG. 6.

As described above, the welding gun adapter 20 includes four connections to the welder 12, two being the power input connections 68 as discussed above. The remaining two connections are trigger circuit connectors 76, which connect the welding gun adapter 20 to the welding gun trigger circuit of the welder 12. The adapter circuit 72 is also connected to the trigger circuit of the 12V spool gun 14 via the welding gun connector 46 (as illustrated in FIGS. 3 and 4). The welding gun connector 46 also includes four connections, two of which are for delivering motor power to the 12V spool gun 14 (e.g., motor power connectors 71), and two of which are for communicating a trigger signal (e.g., gun trigger connectors 73) from the trigger 33 of the 12V spool gun 14 to the adapter circuit 72.

The welding gun trigger circuit and the welder trigger circuit are coupled through circuitry in the adapter circuit 72 to form a system trigger circuit. As such, when the trigger 33 of the 12V spool gun 14 is activated, a trigger signal is transmitted from the 12V spool gun 14 to the welder 12. This allows the welder 12 to respond to the triggering of the 12V spool gun 14 by providing power, etc. In contrast with conventional welding gun trigger circuits which generally reference a control voltage common to detect triggering, the gun trigger circuit of the welding gun adapter 20 works from a simple contact closure. More specifically, to overcome the lack of control circuit voltage common, the optical isolator 74 is employed to sense current in the system trigger circuit, as opposed to trying to sense voltage. When the trigger 33 is depressed or activated in the 12V spool gun 14, the trigger signal is transmitted to the adapter circuit 72 via the gun trigger connectors 73, and the trigger circuit is closed. Current then flows from one terminal of the welder trigger receptacle (e.g., the trigger circuit connections 76) into the welding gun adapter 20, through a rectifying diode bridge 77, and through the optical isolator 74. As such, the connection is not polarity sensitive due to the rectifying diode bridge 77.

In certain embodiments, the optical isolator 74 includes a light-emitting diode and a photo-sensitive transistor. When current flows through the trigger circuit as a result of the gun trigger closure, the light-emitting diode lights, which bias the transistor on and turn the optical isolator 74 on. A gun trigger monitor toggles to an on state condition when the optical isolator 74 is turned on, as the 12V spool gun 14 has been triggered. Additionally, when the optical isolator 74 turns on, current flows through the device, energizing the motor control relay 64. When the motor control relay 64 is energized, the normally-closed contacts that are connected across the spool gun motor winding are opened, and the normally-open contacts are closed, connecting the adapter circuit 72 to the control common, which allows motor current to flow.

When the motor control relay 64 is de-energized, the normally-closed contacts that are connected across the spool gun motor winding are closed, and the normally-open contacts are opened, disconnecting the adapter circuit 72 from control common, halting the motor current. The normally-closed contact closure across the motor winding acts as a “dynamic brake” for the 12V spool gun motor 70, causing it to immediately stop with no coasting. This prevents the 12V spool gun 14 from sending excess welding wire to the weld puddle after power from the welder output 24 of the welder 12 has been removed.

The pulse width modulator 66 controls the voltage, and thus speed, of the 12V spool gun motor 70, which is also activated when the trigger circuit is enabled. The pulse width modulator 66 receives a reference voltage from the potentiometer 56, which outputs a voltage representing the desired motor speed as input by the user. The reference voltage from the potentiometer 56 is compared against a feedback voltage from the 12V spool gun motor 70 by an operational amplifier 78. An error signal is generated from the difference between the reference voltage and the feedback voltage, representing the difference between the desired speed of the 12V spool gun motor 70 and the actual speed of the 12V spool gun motor 70. The error signal is supplied to a compensation pin of the pulse width modulator 66. As the speed of the 12V spool gun motor 70 is determined by the feedback voltage, the pulse width modulator 66 regulates the voltage supplied to the 12V spool gun motor 70 such that the speed of the 12V spool gun motor 70 matches the desired speed. The pulse width modulator 66 regulates the 12V spool gun motor 70 such that all of the motor control voltage levels are below the weld output voltage level.

As such, the welding gun adapter 20 may provide the derived voltage to the 12V spool gun motor 70 of the 12V welding gun 14 using the welding arc voltage from the welder 12. In general, the welding gun adapter 20 is configured to receive the welding arc voltage (e.g., approximately 30 VDC) from the welder 12, and to output a lower derived voltage to the 12V welding gun 14, which may power the 12V spool gun motor 70. For example, in certain embodiments, approximately 17.6 VDC may be provided to the 12V welding gun 14.

Additionally, the functional elements of the welding gun adapter 20 as well as the circuit elements and layout of the welding gun adapter 20 as illustrated in FIGS. 5 and 6 are representative in nature, and provide an exemplary schematic of the adapter electronics. It will be understood that the novel techniques of the present disclosure may be realized with different electronic elements and a circuit layout different than the one illustrated in FIGS. 5 and 6. For example, referring to FIG. 5, the welding gun adapter 20 may be realized without a rectifier 58 while preserving the novelty and technological advancement of the present disclosure. Certain embodiments may also employ different techniques for converting welding power received and transformed into the control power and motor power in place of the techniques described above.

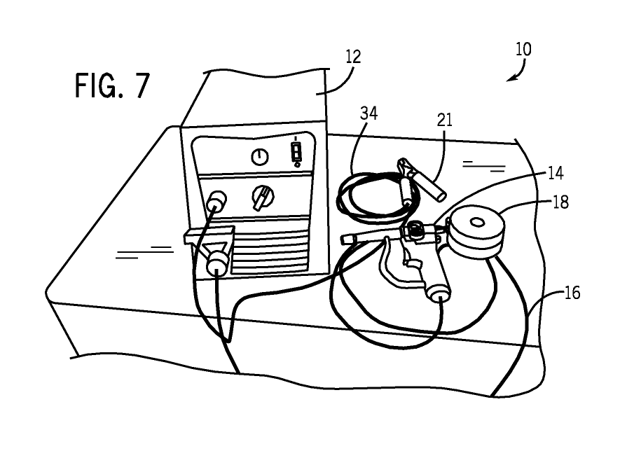

In certain embodiments, the voltage derived from the welding arc voltage of the welder 12 may be provided directly to the 12V spool gun 14, without the welding gun adapter 20. In other words, circuitry similar to that described above with respect to the welding gun adapter 20 may instead be located inside of the welder 12. The 12V spool gun motor 70 is rated at 12V, but may accept, as input, a derived voltage of approximately 15-30V, depending on the particular operating parameters of the 12V spool gun 14. Such an embodiment is depicted in FIG. 7, in which the 12V spool gun 14 is connected to the welding power output of the welder 12 via the welding gun cable 16, in which the welding power output of the welder 12 provides the derived voltage directly from the welder 12. For example, in certain embodiments, the derived voltage supplied to the 12V spool gun 14 may be approximately 17.6 volts and is derived from the welding arc voltage in the welder 12, as opposed to being derived in the welding gun adapter 20. As such, the 12V spool gun 14 may generally be used with a conventional welder 12 that may not otherwise be spool gun ready.

As described above, in certain embodiments, the welding system 10 provides a derived voltage (e.g., approximately 15-30 volts, or a maximum of approximately 17.6 volts) to the 12V spool gun 14, which may be used with conventional welders 12 without the need for a separate power supply to provide motor and control power. In certain embodiments, the 12V spool gun 14 may extract such motor and control power directly from the output welding voltage of the welder 12. In other embodiments, the 12V spool gun 14 may be used with the welding gun adapter 20 for powering the 12V spool gun motor 70 of the 12V spool gun 14 using weld power from the welder 12. The welding gun adapter 20 is configured to receive an input of the welding arc voltage, such as 30 VDC, from the welder 12, and to output a lower DC voltage (e.g., the derived voltage of approximately 15-30 volts, or a maximum of approximately 17.6 volts) to the 12V spool gun 14.

While only certain features of the invention have been illustrated and described herein, many modifications and changes will occur to those skilled in the art. It is, therefore, to be understood that the appended claims are intended to cover all such modifications and changes as fall within the true spirit of the invention.

1-20. (canceled)

21. A welding system, comprising:
a welding power supply configured to output a welding voltage;
a motor power supply configured to derive a motor voltage from the welding voltage, wherein the welding voltage is provided to the motor power supply via a first electrical connection to the welding power supply; and
a welding gun, configured to receive the welding voltage via a second electrical connection to the welding power supply and receive the motor voltage via a third electrical connection to the motor power supply, comprising:
a spindle configured to receive a welding wire spool of a welding filler metal wire, wherein the welding voltage is provided to the welding filler metal wire to establish an arc between the welding filler metal wire and a workpiece; and
a motor configured to use the motor voltage to drive rotation of a feed roll that draws the welding filler metal wire from the welding wire spool.

22. The welding system of claim 21, wherein the motor is a 12-V motor.

23. The welding system of claim 21, wherein the motor voltage is a regulated voltage less than the welding voltage.

24. The welding system of claim 21, wherein the motor voltage is less than 17.6 volts.

25. The welding system of claim 21, comprising a welding cable that comprises the second electrical connection and a conduit configured to provide shielding gas from the welding power supply to the welding gun.

26. The welding system of claim 21, wherein the motor power supply is one of: external to the welding power supply or integrated as a part of the welding power supply.

27. The welding system of claim 21, wherein the motor power supply is separate from the welding gun.

28. The welding system of claim 21, comprising, when the motor power supply is external to the welding power supply, a welding gun adapter comprising the motor power supply, wherein:
the first electrical connection is configured to be removably electrically coupled to one or both of the welding gun adapter and the welding power supply,
the second electrical connection is configured to be removably electrically coupled to one or both of the welding gun adapter and the welding gun, and
the third electrical connection is configured to be removably electrically coupled to one or both of the welding power supply and the welding gun.

29. The welding system of claim 28, wherein the welding gun adapter comprises control circuitry to control a speed of the motor.

30. The welding system of claim 29, wherein the welding gun adapter comprises a motor speed controller configured to adjust the speed of the motor.

31. The welding system of claim 30, wherein the motor speed controller is one of: an adjustment knob or a sliding controller.

32. The welding system of claim 30, wherein the motor speed controller is an only input device of the welding gun adapter.

33. The welding system of claim 28, wherein the welding gun adapter comprises an adapter housing with a top cover and a bottom cover, wherein the top and bottom covers are made of a plastic material.

34. The welding system of claim 28, comprising:
a trigger in the welding gun configured to generate trigger signals when the trigger is activated; and
welding gun trigger circuitry in the welding gun adapter, wherein the trigger signals are communicated to the welding power supply via the welding gun trigger circuitry,
wherein the trigger signals are used to control the welding voltage.

35. The welding system of claim 21, comprising, when the motor power supply is integrated as a part of the welding power supply:
the second electrical connection is configured to be removably electrically coupled to one or both of the welding power supply and the welding gun, and
the third electrical connection is configured to be removably electrically coupled to one or both of the welding power supply and the welding gun.

36. A welding system, comprising:
a welding power supply configured to output a welding voltage;
a welding gun adapter comprising:
a motor power supply configured to derive a motor voltage from the welding voltage; and
a welding gun trigger circuitry,
wherein:
the motor power supply is a separate power supply external to the welding power supply and external to a welding gun, and
the welding voltage is provided to the motor power supply via a first electrical connection to the welding power supply;
a welding gun, configured to receive the welding voltage via a second electrical connection to the welding power supply and receive the motor voltage via a third electrical connection to the motor power supply, comprising:
a spindle configured to receive a welding wire spool of a welding filler metal wire, wherein the welding voltage is provided to the welding filler metal wire to establish an arc between the welding filler metal wire and a workpiece;
a motor configured to use the motor voltage to drive rotation of a feed roll that draws the welding filler metal wire from the welding wire spool; and
a trigger configured to generate trigger signals when the trigger is activated,
a fourth electrical connection configured to communicate the trigger signals from the welding gun to the welding gun adapter; and
a fifth electrical connection configured to communicate the trigger signals from the welding gun adapter to the welding power supply,
wherein the trigger signals are used to control the welding voltage.

37. The welding system of claim 36, wherein the motor is a 12-V motor.

38. The welding system of claim 36, comprising a welding cable that comprises the second electrical connection and a conduit configured to provide shielding gas from the welding power supply to the welding gun.

39. A welding system, comprising:
a welder comprising:
a welding power supply configured to output a welding voltage; and
a motor power supply configured to derive a motor voltage from the welding voltage, wherein motor power supply is configured to receive the welding voltage via a first electrical connection;
a welding gun, configured to receive the welding voltage via a second electrical connection to the welder and receive the motor voltage via a third electrical connection to the welder, comprising:
a spindle configured to receive a welding wire spool of a welding filler metal wire, wherein the welding voltage is provided to the welding filler metal wire to establish an arc between the welding filler metal wire and a workpiece;
a motor configured to use the motor voltage to drive rotation of a feed roll that draws the welding filler metal wire from the welding wire spool; and
a trigger configured to generate trigger signals when the trigger is activated; and
a fourth electrical connection configured to communicate the trigger signals to the welder, wherein the trigger signals are used to control the welding voltage.

40. The welding system of claim 39, wherein the motor is a 12-V motor.
